(19) United States
(12) Patent Application Publication
(10) Pub. No.: US 2008/0051951 A1
(43) Pub. Date: Feb. 28, 2008

(54) Automated Parking System

(76) Inventor: Cecelia Camacho, Auburn, WA (US)

Correspondence Address: SPECKMAN LAW GROUP PLLC, 1201 THIRD AVENUE, SUITE 330, SEATTLE, WA, 98101, US

(21) Appl. No.: 11/770,647

(22) Filed: Jun. 28, 2007

Related U.S. Application Data
(60) Provisional application No. 60/806,718, filed on Jul. 6, 2006.

(51) Int. Cl. G05D 1/00

(52) U.S. Cl. 701/23

(57) ABSTRACT

An automated parking system is capable of parking, transporting, storing and retrieving a plurality of vehicles. The system comprises a guiding system; at least one communication system provided with a tracking system; a transport system including at least one movable transporter for transporting the vehicles and at least one vertical transport facility for transporting the movable transporter, wherein the automated parking system provides a parking scheme comprising at least one unoccupied parking space in a parking area.

### CROSS REFERENCE TO RELATED APPLICATION

This application claims priority under 35 U.S.C. §119(e) to U.S. Provisional Patent Application No. 60/806,718, filed Jul. 6, 2006.

### FIELD OF INVENTION

This invention relates generally to a parking system, and more particularly to an automated or robotic parking system.

### BACKGROUND OF THE INVENTION

Locating a vacant parking space is an ordeal that causes frustration for many drivers. Even if a driver pays to enter a parking structure, valuable time is consumed searching for a parking space within the parking structure. It seems that parking structures that service hospitals, airports, mass transit stations, entertainment forums, shopping malls, and the like are always the most crowded when time is the most crucial. As urban and suburban regions become more populated, finding a vacant parking space will become increasingly difficult for drivers. It is also often difficult for parking structure operators or attendants to know of or locate open parking spaces in a parking structure. Parking structure operators or attendants therefore cannot assist drivers to find open parking spaces efficiently, and the main duty of a parking structure operator or attendant is to merely collect parking fees when drivers exit the parking structure.

Various systems have been designed for guiding drivers to an open parking space after entering a parking structure. This type of parking structure management system presents, at the entrance to the parking structure, the location of an open parking space, lends a communication terminal to the driver or parking structure operator, and uses text displays or audio output from the communication terminal to guide the driver or the parking structure operator to the open parking space.

One problem with the parking structure management system mentioned above, however, is that it is difficult for the driver to know the location of the open parking space because the driver is guided to the open space with text or audio guidance from a communication terminal inside the parking structure. A further problem is that it is difficult for the driver to know the position of the open parking space relative to the driver's own current location. Furthermore, if the relationship between these two positions is unclear, the driver may become lost inside the parking structure. Thus, this type of parking structure management system is not efficient for drivers or parking structure operators.

U.S. Pat. No. 6,946,974 discloses a parking system comprising an internet-accessible web server that stores substantially real-time parking data associated with occupancy of a plurality of parking spaces. The parking data can be accessed by a display device running a browser application. The web server, which transmits the parking data in response to a request sent from the browser application, communicates with at least one of a detector and a parking terminal configured to collect and transmit parking data.

U.S. Pat. No. 6,823,317 discloses a wireless network covering a large local geographic area that is used to link a large number of parking payment terminals provided in the same area. Each payment terminal is located near a plurality of parking spaces, either at the curbside or in municipal lots. Parking data is gathered from motorists at the payment terminals, that includes vehicle identification data or parking space identification data. The parking data is sent from the payment terminals to the wireless network in response to payment made at the payment terminals. A plurality of portable terminals is provided for use by parking wardens inspecting the parking spaces of the local geographic area. The wireless network transmits the parking data substantially upon receipt from the payment terminals to the portable terminals.

U.S. Pat. No. 6,750,786 discloses a parking system comprising a wireless communications device capable of accessing a server over the internet and a software application for receiving parking data transmitted over the internet to the wireless communications device. The wireless communications device can provide the parking data as a substantially real-time representation indicating an occupancy condition of an available parking lot. The occupancy condition changes according to presence and absence of vacant parking spaces within the available parking lot.

U.S. Pat. No. 6,889,889 discloses a parking system comprising a parking meter provided with a transmitter receiver for transmitting and receiving information. The transmitter receiver communicates with a host central station for receiving and transmitting information. In order to park at the meter, a user telephones a telephone number associated with the parking meter and connects with the host station. Commands are input into the user's telephone to provide an indication of the amount of parking time required and payment for the parking time and information is downloaded from the station to the parking meter to indicate that parking has been paid for and the parking meter should activate to indicate that parking has been paid for. Parking bays associated with meters may include sensors for indicating the presence of a vehicle and for providing a signal to the parking meter in the event that parking time expires and the car is still present in the parking place so that appropriate action can be taken.

U.S. Pat. No. 6,885,311 discloses a parking system comprising one or more wireless vehicle detectors, along with a distributed parking payment system such as parking meters or a pay station. Information from the payment system and the vehicle detectors may be combined to determine when a parking violation occurs, or is about to occur. This information may then be transmitted through a communication system to a parking enforcement officer, along with information about the geographic location of the violation.

U.S. Pat. No. 6,650,250 discloses a parking lot guidance system which is capable of guiding parking lot users to empty parking spaces in a large-scale parking lot in a way that is easy for the user to understand. The parking lot guidance system is provided with a vehicle detection unit for detecting vehicles parked in parking spaces, a control unit for generating parking space availability data for the parking lot based on detection results from the vehicle detection unit, a parking lot map storage unit for storing maps of the parking lot, an empty space data storage unit for storing the empty parking space data generated by the control unit, and data transmitters for sending the empty parking space data to optical beacons located at various places throughout the parking lot. When a vehicle enters a specific parking block in a parking lot, data indicating the location of available parking spaces are sent to the vehicle.

### SUMMARY OF THE INVENTION

An automated parking system capable of parking, transporting, storing and retrieving a plurality of vehicles is provided. The disclosed automated parking system comprises a guiding system and a transport system. In one embodiment, the guiding system comprises at least one guiding track embedded in the floor of a parking structure, and the transport system is provided with at least one movable transporter for transporting vehicles according to a generally horizontal parking arrangement in the parking structure and at least one vertical transport facility for transporting the transporter from one level to another in the parking structure. By way of the vertical transport facility, the transporter can be moved vertically or horizontally among floors of the parking structure and can then be moved to desired locations(s) on each floor of the parking structure.

Each transporter comprises a floor, a plurality of wheels positioned at a bottom area of the transporter's floor for providing mobility on the guiding track(s) embedded in the floor of the parking structure, and at least one computer processor. The transporter is movable by way of the wheels and the guiding track(s), and the guiding track(s) provide power to the transporter for mobility. The computer processor, which is provided with a unique and trackable identifier, is in electronic communication with the automated parking system on each level of the parking structure. In one embodiment, the movable transporter is a transport platform. The transporter further comprises a brake system which is connected to the wheels of the transporter.

In one embodiment, the vertical transport facility is an elevator shaft. The elevator shaft comprises a frame and a plurality of tracks to which the transporter can be attached, so that the transporter may be lifted or lowered to any desired level of a parking structure. In one embodiment, the elevator shaft remains stationary while the transporter travels on the elevator shaft. The elevator shaft is capable of holding a first transporter in place while a second transporter is being transported to another parking level. A clamp mechanism is provided on the transporter and the elevator shaft in order to secure the transporter to the elevator shaft, while allowing vertical, forward, backward, or side to side gliding movement of the transporter on the surface of the elevator shaft.

The disclosed automated parking system further comprises at least one communication system provided with a tracking system and a database for monitoring the locations of the parked vehicles and the availability of parking spaces in the parking structure. The tracking system is capable of providing real time tracking of independent parked vehicles by way of each transporter's computer processor provided with a unique and trackable identifier. The unique and trackable identifier may also be tagged with each vehicle. The communication system further comprises a computer system capable of providing a parking scheme for the automated parking system. The computer system assumes that each vertical level of the parking structure comprises at least one parking area. Each parking level may contain any number of parking areas. The parking scheme is governed by rules that retain at least one unoccupied parking space in the parking area.

The communication system may be provided with a classification system to classify different types and sizes of vehicles, and may further be provided with an automated payment system for payment of parking fees.

In operation, a driver arrives at a waiting area of a parking structure with his/her vehicle. After parking the vehicle at the waiting area, the driver is provided with an electronic parking card and the driver swipes or inserts the parking card at the communication system to generate an arrival time. The generated arrival time is recorded by the communication system's computer system and database. The driver may optionally enter expected retrieval/pickup time of the vehicle into the communication system. After the computer system and database record the arrival time and/or the retrieval time of the vehicle, the movable transporter is assigned to the vehicle and the vehicle is placed on or driven onto the transporter. The transporter is then securely connected to the vertical transport facility and transported to an assigned parking level and parking space according to the entered retrieval time. When the driver returns to the parking structure to retrieve the vehicle, the parking card is swiped or inserted at the communication system and the automated parking system begins locating the vehicle. After the vehicle is located, the automated parking system proceeds to move the transporter towards the vertical transport facility. After the transporter is secured to the vertical transport facility by way of the clamp mechanism, the transporter travels to the first level of the parking structure and travels towards the waiting area so that the driver can retrieve the vehicle.

### BRIEF DESCRIPTION OF THE DRAWINGS

The disclosed invention will be described in greater detail in the following detailed description, with reference to the accompanying drawings, wherein:

FIG. 1 shows a flow chart of an embodiment of the disclosed automated parking system, illustrating a vehicle parking/storage process;

FIG. 2 shows an example of a parking arrangement which may be used in connection with an embodiment of the disclosed automated parking system;

FIG. 3 shows a vehicle movement process and arrangement generated by the disclosed automated parking system; and

FIG. 4 shows a flow chart of an embodiment of the disclosed automated parking system, illustrating a vehicle retrieval process.

### DETAILED DESCRIPTION OF THE INVENTION

An automated parking system capable of parking, transporting, storing and retrieving a plurality of vehicles is provided. The disclosed automated parking system comprises a guiding system and a transport system. In one embodiment, the guiding system comprises at least one guiding track embedded in the floor of a parking structure, and the transport system is provided with at least one movable transporter for transporting vehicles according to a generally horizontal parking arrangement in the parking structure and at least one vertical transport facility for transporting the transporter from one level to another in the parking structure. By way of the vertical transport facility, the transporter can be moved vertically or horizontally among floors of the parking structure and can then be moved to desired locations(s) on each floor of the parking structure.

The transporter may be constructed of any type of durable metal. In one embodiment, the transporter is constructed of steel grates. In general, the transporter is constructed such that it is able to withstand a weight of about 5,000 lb or 2000 kg. The transporter may be in any configuration including, but not limited to, square, rectangular, oval, circular and the like. In one embodiment, the transporter has a width of about 8 feet or 200 cm and a length of about 8 feet or 200 cm.

Each movable transporter comprises a floor, a plurality of wheels positioned at a bottom area of the transporter's floor for providing mobility on the guiding track(s) embedded in the floor of the parking structure, and at least one computer processor. The transporter is movable by way of the wheels and the guiding track(s), and the guiding track(s) provide power to the transporter for mobility. The floor of the transporter may be provided with grates, grips, bumpers or the like in order to secure at least one vehicle in place on the transporter. In one embodiment, the transporter can accommodate one vehicle. In another embodiment, the transporter can accommodate two vehicles. In yet another embodiment, the transporter can accommodate four vehicles. In still another embodiment, the transporter can accommodate six vehicles. The computer processor, which is provided with a unique and trackable identifier, is in electronic communication with a control center of the automated parking system on each level of the parking structure. In one embodiment, the control center is capable of receiving, storing, processing, and transmitting electronic signals. Electronic communications may be by means of a wired electronic system or a wireless electronic system. In one embodiment, the movable transporter is a transport platform. The transporter further comprises a brake system which is connected to the wheels of the transporter. The brake system may be activated via electronic signals generated from the transporter's computer processor.

In one embodiment, the vertical transport facility is an elevator shaft. The elevator shaft comprises a frame and a plurality of tracks to which the transporter is attachable so that the transporter may be lifted or lowered to any desired level of a parking structure. The transporter is movable vertically or horizontally within the parking system via attachments to the elevator shaft. In one embodiment, the elevator shaft remains stationary while the transporter travels on the elevator shaft. The elevator shaft is capable of holding a first transporter in place while a second transporter is being transported to another parking level.

A clamp mechanism is provided on the transporter and the vertical transport facility in order to secure the transporter to the vertical transport facility, while allowing vertical, forward, backward, or side to side gliding movement of the transporter on the surface of the vertical transport facility. The clamp mechanism releases the transporter from the vertical transport facility after the transporter is positioned on a parking level. The release of the transporter allows the transporter to travel horizontally within the parking system.

The disclosed automated parking system further comprises at least one communication system provided with a tracking system and a database for monitoring the locations of the parked vehicles and the availability of parking spaces in the parking structure. The tracking system is capable of providing real time tracking of independent parked vehicles by way of a unique and trackable identifier associated with each vehicle or each transporter.

The tracking system is provided with a computer system or server capable of providing a parking scheme for the disclosed automated parking system. The computer system assumes that each level of a parking structure comprises at least one parking area. Each parking level may contain any number of parking areas. The computer system utilizes the following formula to determine the number of parking spaces available in a parking area:

$${\sum }_{i = n} n \hat{} 2 - 1$$

wherein n equals number of rows in each parking area. n is squared and subtracted by one (1) to create the total number of parking spaces available per parking area. The subtraction of one (1) from n ensures that at least one parking space always remains unoccupied in the parking area.

The computer system of the tracking system may also generate electronic signals to activate and control the transporter's brake system.

According to the parking scheme provided by the above formula, the transporter holding the vehicles slated for the earliest retrieval or pickup time are placed as close to the vertical transport facility as possible. In one embodiment, a first transporter may be moved to accommodate a second transporter that has been assigned an earlier retrieval time than that of the first transporter.

The communication system may be provided with a classification system to classify different types and sizes of vehicles, and may further be provided with an automated payment system for payment of parking fees.

In operation, a driver arrives at a waiting area in a parking structure with his/her vehicle. After parking the vehicle, the driver is provided with an electronic parking card and the driver swipes or inserts the parking card at the communication system to generate an arrival time. The generated arrival time is recorded by the communication system's computer system and database. The driver may optionally enter retrieval/pickup time of the vehicle (N_{Time}≧0) into the communication system. The driver may also choose to leave the vehicle retrieval time blank. After the computer system and database record the arrival time and/or the retrieval time of the vehicle, the movable transporter is assigned to the vehicle and the vehicle is placed on or driven onto the transporter. The transporter, with the vehicle secured, is placed in the vertical transport facility and transported to an assigned parking level and parking space according to the entered retrieval time. Since there is always one empty parking space available in a parking area of the disclosed automated parking system, the automated parking system allows the constant rearrangement of parked/stored vehicles while accommodating other vehicles that arrive at the parking structure.

When the driver returns to the parking structure to retrieve the vehicle, the parking card is swiped or inserted at the communication system and the system begins locating the vehicle by way of information (location of the transporter, parking space number and the like) that was stored in the database of the communication system's computer system. After the vehicle is located, the automated parking system proceeds to move the transporter with the secured vehicle towards the vertical transport facility. After the transporter is secured to the vertical transport facility by way of the clamp mechanism, the transporter travels to the first level of the parking structure and travels towards a waiting area. When the vehicle is removed or driven off from the transporter, the transporter travels to the beginning position so that another vehicle can be placed on the transporter. If there is not another vehicle to be transported, the transporter travels to a parking level with unoccupied parking spaces, and the transporter is dispatched when another vehicle needs to be transported and parked.

### EXAMPLE 1

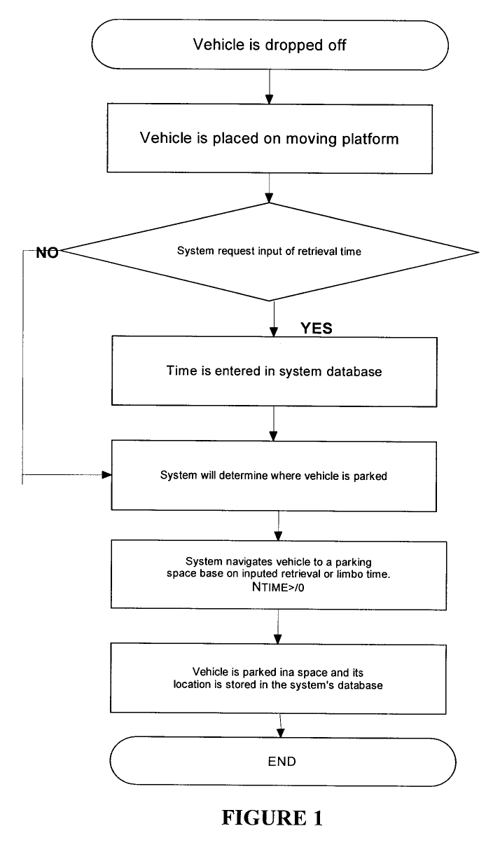

This example illustrates an embodiment of the disclosed automated parking system. FIG. 1 is a flow chart illustrating an exemplary vehicle parking process generated by the automated parking system.

As shown in FIG. 1, after a vehicle arrives at a parking structure, the vehicle is first placed on a movable transport platform. The driver swipes or inserts an electronic parking card at a communication terminal and a computer system of the terminal requests input of the vehicle retrieval time. After the vehicle retrieval time is entered, it is recorded in the database of the computer system, and the parking system calculates and generates a parking space in which the vehicle will be parked/stored. Even if a vehicle retrieval time is not entered (“limbo” time), the system still calculates and generates a parking space in which the vehicle will be parked/stored. Based on the entered vehicle retrieval time, or on “limbo” time, the parking system navigates the transport platform, with the secured vehicle, to an available parking space in the parking structure.

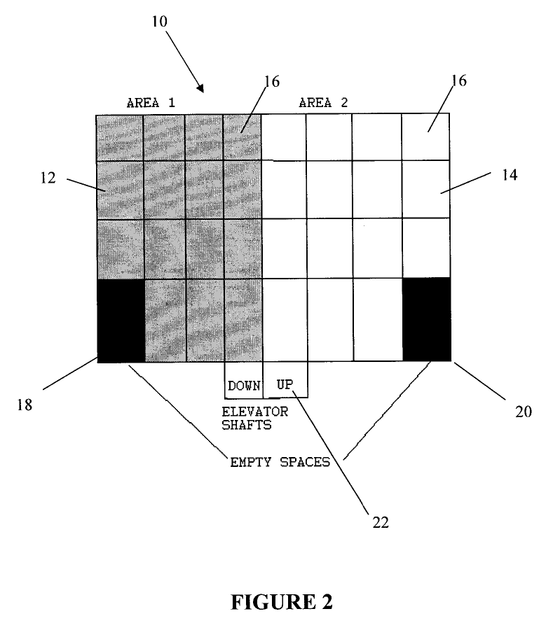

FIG. 2 shows an exemplary parking space arrangement 10 that can be utilized in connection with the disclosed automated parking system. In this example, the parking space arrangement 10 comprises two parking areas 12 and 14 that make up a parking level. In this embodiment, each parking area 12 and 14 contains fifteen parking spaces 16, and the parking level contains thirty parking spaces 16. Each parking space 16 is provided with a transport platform. As shown in FIG. 2, each parking area 12 and 14 is provided with one empty parking space 18 and 20. In this example, empty parking space 18 is located at the front corner of parking area 12, and empty parking space 20 is located at the front corner of parking area 14. It will be understood that empty parking spaces 18 and 20 may be positioned in any space of parking areas 12 and 14. In operation, empty parking spaces 18 and 20 move about parking areas 12 and 14 according to the parking arrangement determined by the formula shown above. The transport platforms may be moved until the platforms clear a way for a designated transport platform to reach the elevator shaft 22.

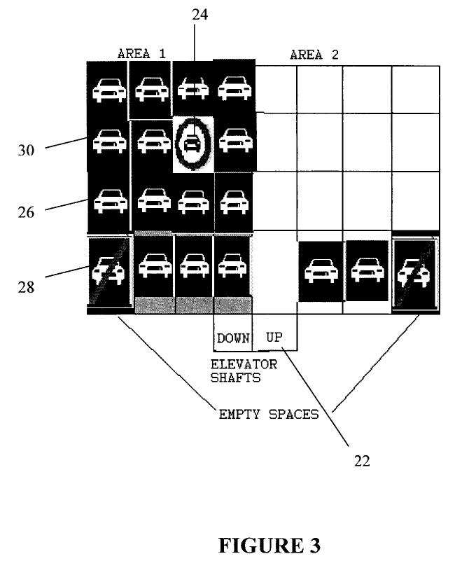

FIG. 3 shows a vehicle movement process and arrangement generated by the disclosed automated parking system. In FIG. 3, vehicle transport platform 24 is the targeted platform being transported towards elevator shaft 22. When the transport process begins, transport platform 26 travels to empty parking space 28. After platform 26 travels to empty space 28, the parking space where platform 26 was originally positioned becomes a new empty parking space, allowing platform 30 to move to this newly created empty parking space. It shall be understood that any of the transport platforms may be transported to and from any parking spaces. This transport process continues until targeted transport platform 24 is positioned adjacent to elevator shaft 22. This vehicle movement process ensures none of the empty parking spaces is permanently empty due to the constantly changing parking space arrangement.

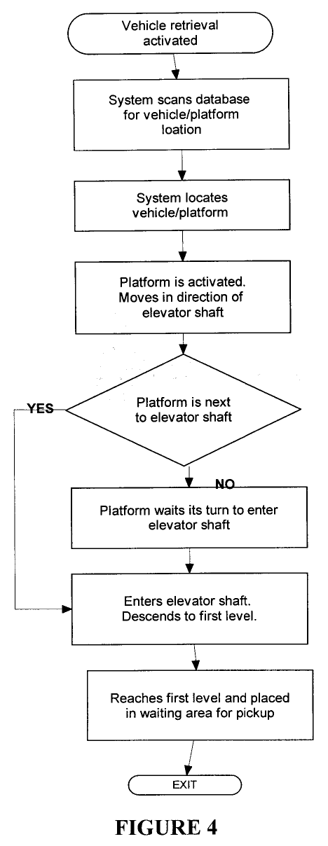

FIG. 4 shows a flow chart illustrating an exemplary vehicle retrieval process generated by the parking system. When the driver returns to the parking structure and swipes or inserts the parking card at the communication terminal, the vehicle retrieval process is initiated. The computer system of the communication terminal scans the database for the location of the transport platform holding the desired vehicle to be retrieved. After the vehicle to be retrieved is located, the transport platform holding the vehicle is activated and travels towards the elevator shaft. If the transport platform is positioned adjacent to the elevator shaft, the transport platform attaches to the elevator shaft and travels to the first level of the parking structure. The vehicle is then placed in a waiting area on the first level of the parking structure so that the driver may retrieve the vehicle.

If the transport platform is not positioned adjacent to the elevator shaft, the platform holding the vehicle to be retrieved is transported towards the elevator shaft in a similar process to that illustrated in FIG. 3.

While certain embodiments of the present invention have been described in detail, it will be understood that various changes could be made in the above constructions without departing from the scope of the invention. It is intended that all matter contained in the above description or shown in the accompanying drawing shall be interpreted as illustrative and not in a limiting sense.

I claim:

1. An automated parking system capable of parking, transporting, storing and retrieving a plurality of vehicles, comprising:
(a) a guiding system;
(b) at least one communication system provided with a tracking system; and
(c) a transport system comprising at least one movable transporter for
transporting the vehicles according to a parking arrangement in a parking structure, and at least one vertical transport facility for transporting the movable transporter from one level to another in the parking structure,
wherein the guiding system comprises at least one guiding track embedded in the floor of the parking structure, providing mobility for the movable transporter, wherein the movable transporter can be moved vertically among floors of the parking structure and can be moved to desired locations(s) on each floor of the parking structure, and wherein the automated parking system provides a parking scheme having at least one unoccupied parking space in a parking area.

2. The automated parking system of claim 1, wherein the transporter is constructed of at least one steel grate.

3. The automated parking system of claim 1, wherein the configuration of the transporter is selected from the group consisting of: square, rectangular, oval and circular.

4. The automated parking system of claim 1, wherein the movable transporter comprises
(a) a floor provided with grates, grips or bumpers, in order to secure a vehicle in place on the movable transporter;
(b) a plurality of wheels for providing mobility on the at least one guiding track; and
(c) at least one computer processor that communicates electronically with the automated parking system on each level of the parking structure,
wherein the moveable transporter is movable by way of the wheels and the guiding track(s).

5. The automated parking system of claim 4, wherein the at least one computer processor communicates electronically with the automated parking system by means of a wired electronic system or a wireless electronic system.

6. The automated parking system of claim 4, wherein the movable transporter further comprises a brake system that communicates with the tracking system that is activated via electronic signals generated from the transporter's computer processor.

7. The automated parking system of claim 1, wherein the movable transporter is a transport platform.

8. The automated parking system of claim 1, wherein the vertical transport facility is an elevator shaft that comprises a frame and a plurality of tracks to which the movable transporter is attachable, whereby the movable transporter may be lifted or lowered to any desired level of the parking structure, wherein the transporter is movable vertically or horizontally within the parking system via attachments to the elevator shaft, wherein the elevator shaft remains stationary while the transporter travels on the elevator shaft, and wherein the elevator shaft is capable of holding a first transporter in place while a second transporter is being transported to another parking level.

9. The automated parking system of claim 1, wherein the transport system comprises a clamp mechanism that releasably secures the movable transporter to the vertical transport facility and releases the transporter from the vertical transport facility after the movable transporter is positioned on a parking level.

10. The automated parking system of claim 1, further comprising at least one communication system provided with a tracking system and a database for monitoring locations of parked vehicles and the availability of parking spaces in the parking structure, wherein the tracking system is capable of providing real time tracking of independent parked vehicles by way of a unique and trackable identifier tagged with each vehicle or each transporter.

11. The automated parking system of claim 1, wherein the tracking system comprises a computer system capable of providing a parking scheme for the parking system.

12. The automated parking system of claim 11, wherein the moveable transporter is further provided with a brake system and the computer system generates electronic signals to activate and control the brake system.

13. The automated parking system of claim 1, wherein the movable transporter holding vehicles slated for earliest retrieval or pickup time are placed as close to the vertical transport facility as possible.

14. The automated parking system of claim 1, further comprising a classification system to classify different types and sizes of vehicles.

15. The automated parking system of claim 1, further comprising an automated payment system for payment of parking fees.

16. A method for parking, transporting, storing and retrieving a plurality of vehicles in a parking structure, comprising:
(a) providing a driver with an electronic parking card after a driver arrives at the parking structure with his/her vehicle and parks the vehicle in a waiting area of the parking structure;
(b) generating an arrival time after the driver presents the parking card at a communication system; and
(c) recording the generated arrival time in a computer system and database connected to the communication system.

17. The method of claim 16, further comprising:
(a) recording a desired retrieval time of the vehicle in the computer system and database;
(b) assigning a specific movable transporter identifier to the vehicle;
(c) placing the movable transporter on a vertical transport facility; and
(d) transporting the movable transporter to an assigned parking level and parking space according to the retrieval time.

18. The method of claim 16, further comprising:
(a) locating the vehicle by way of the location of the transporter and a parking space number stored in the database of the communication system after the parking card is further presented at the communication system;
(b) moving the transporter secured with the vehicle towards the vertical transport facility; and
(c) moving the transporter to waiting area on a first level of the parking structure.

19. The method of claim 18, wherein the movable transporter is moved to a beginning position after the vehicle is removed from the movable transporter so that another vehicle can be placed on the movable transporter.

20. The method of claim 19, wherein the moveable transporter is moved to a parking level with unoccupied parking spaces and is dispatched when another vehicle needs to be transported and parked.
